(19) United States
(12) Patent Application Publication
(10) Pub. No.: US 2010/0124081 A1
(43) Pub. Date: May 20, 2010

(54) SWITCHING POWER SUPPLY

(75) Inventors: Naohiko Morota, Hyogo (JP); Kazuhiro Murata, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/581,348

(22) Filed: Oct. 19, 2009

(30) Foreign Application Priority Data
Nov. 19, 2008 (JP) 2008-295004

(51) Int. Cl. H02M 3/335

(52) U.S. Cl. 363/21.16

(57) ABSTRACT

According to the present invention, when a secondary current on period T2on reaches a predetermined maximum secondary current on-period, an overload is detected and an output power is controlled to decrease. Further, a maximum secondary current on-period signal is set so as to correspond to a secondary current on-period when constant voltage control is performed on an output voltage.

### REFERENCE TO RELATED APPLICATIONS

The disclosure of Japanese Patent Application No. 2008-295004 filed Nov. 19, 2008 including specification, drawings and claims is incorporated herein by reference in its entirety.

### FIELD OF THE INVENTION

The present invention relates to a switching power supply which acts as a power supply and has an overload protection function for a secondary side output against the load of the power supply.

### BACKGROUND OF THE INVENTION

In recent years, in switching power supplies used as power supplies for electronic equipment and so on, an overload protection function has become necessary for secondary side outputs against the loads of the power supplies.

In a known overload protection technique for a secondary side output, a current to a load is monitored using a sensing resistor and the like on the secondary side, an overload is detected using a sensing IC and the like on the secondary side, and then an overload signal is directly fed back to the primary side with a photocoupler and the like for outputting the overload signal.

The sensing IC on the secondary side and the photocoupler for outputting the overload signal are, however, expensive power supply components which have increased the costs of switching power supplies and interfered with the size reduction of the switching power supplies. Japanese Patent Laid-Open No. 2006-034045 discloses a technique in which a sensing IC on the secondary side and a photocoupler for outputting an overload signal are omitted and the overload of a secondary side output is detected by feeding back secondary-side output information to the primary side with a photocoupler.

A switching power supply disclosed in Japanese Patent Laid-Open No. 2006-034045 is a switching power supply for current-mode PWM control in which the element current of a switching element is controlled in response to a feedback signal to control an output voltage. When the element current of the switching element reaches a maximum element current ILIMIT, a feedback signal level is used as an overload detection level. An overload detection signal is generated at this point and an output is reduced by stopping oscillation for the switching operation of the switching element, so that with the single feedback signal, the element current can be controlled at a normal load and the overload detection signal can be generated at an overload.

FIG. 11 shows the switching power supply of the prior art disclosed in Japanese Patent Laid-Open No. 2006-034045. In FIG. 5, characteristic A1 indicated by a dotted line is an output current-output voltage characteristic in the presence of the overload protection function of the switching power supply according to Japanese Patent Laid-Open No. 2006-034045, and characteristic A2 indicated by a broken line is an output current-output voltage characteristic in the absence of the overload protection function.

In the switching power supply of Japanese Patent Laid-Open No. 2006-034045, an output current at which an overload is detected (overload detection point) is set at point A in FIG. 5. Point A is the same point as a point where the element current of the switching element reaches the maximum value ILIMIT.

In the prior art, however, an overload state of the secondary side is detected using the feedback signal from the photocoupler, the feedback signal being substantially set at 0 when the peak element current of the switching element reaches the maximum value ILIMIT set by a control circuit 20, as shown in FIG. 5.

Thus an output current (maximum output current) Io when an overload is detected is represented by expression (1):

$$Io = \frac{L 2 \times I 2 {p}^{2}}{2 \times T \times Vo} = \frac{L \times {ILIMIT}^{2}}{2 \times T \times Vo} \qquad ( 1 )$$

where Vo is the output voltage of the secondary side (supply voltage to a load), ILIMIT is the maximum element current, fosc is the switching frequency of the switching element (the oscillatory frequency of an oscillator), T=1/fosc is the switching period of the switching element (the oscillation period of an oscillator), and L is an inductance value on the primary side of a transformer.

L2: the inductance of a secondary winding

I2p: the peak of a secondary side current

In the prior art, as expressed in expression (1), the maximum output current Io is proportionate to the square of the maximum element current ILIMIT. It is known that the maximum element current ILIMIT depends upon an input voltage because of the delay time of the control circuit 20.

Further, U.S. Pat. No. 6,781,357 discloses a technique for reducing the dependence on input voltage. This technique is not so versatile as to provide the same effect for all power specifications. As a result, even if this technique is used, an output current during the detection of an overload may somewhat depend upon an input voltage according to the power specifications.

When such a switching power supply is used for, for example, worldwide specifications, it is necessary to increase the ratings of the circuit components of electrical equipment acting as a load, thereby increasing the cost of components.

### DISCLOSURE OF THE INVENTION

In view of the problem of the prior art, an object of the present invention is to provide a switching power supply which can detect an overload only with low dependence on an input voltage on the primary side without using a photocoupler for detecting an overload or an IC for detecting a secondary-side output voltage with an overload detection function.

In order to solve the problem, a switching power supply of the present invention includes a transformer having a primary winding, a secondary winding, and an auxiliary winding; a switching element connected to the primary winding to switch a first DC voltage supplied to the primary winding; a control circuit for controlling the switching operation of the switching element; an output voltage generating circuit which converts, to a second DC voltage, an AC voltage generated on the secondary winding by the switching operation of the switching element and supplies the second DC voltage to a load; and an output voltage transmission circuit which detects the second DC voltage from the output voltage generating circuit, generates a transmission signal changing with the second DC voltage, and transmits the signal to the control circuit, the control circuit controlling the switching operation of the switching element to perform constant voltage control on the second DC voltage from the output voltage generating circuit, the control circuit including: an element current detection circuit which detects a current passing through the switching element and outputs the current as an element current detection signal; a feedback signal control circuit which compares the transmission signal from the output voltage transmission circuit with a reference level and outputs the error as a feedback signal; a switching signal control circuit which controls the second DC voltage from the output voltage generating circuit by controlling a switching signal for turning on/off the switching operation of the switching element based on the element current detection signal from the element current detection circuit and the feedback signal from the feedback signal control circuit; a secondary current on-period detection circuit which detects, from a voltage generated on the auxiliary winding by the switching operation of the switching element, a time when the passage of a secondary current through the secondary winding is completed after the switching element is turned off, generates a signal indicating a time when the secondary current is cut off, detects as a secondary current on-period a time period from a time the switching element is turned off until the time the secondary current is cut off, converts the time period to one of a voltage signal and a current signal, and outputs the signal; and an output power limiting circuit which compares the output signal of the secondary current on-period detection circuit and a signal indicating a predetermined maximum secondary current on-period, and outputs an output power limit signal to the switching signal control circuit, the output power limit signal reducing or stopping power supply to the load when the output signal of the secondary current on-period detection circuit is larger than the maximum secondary current on-period signal, the maximum secondary current on-period signal being set so as to correspond to the secondary current on-period when the constant voltage control is performed on the second DC voltage from the output voltage generating circuit by the switching operation of the switching element.

Further, the output power limiting circuit outputs the output power limit signal to the switching signal control circuit when the secondary current on-period is kept larger than the maximum secondary current on-period for a certain period of time after the secondary current on-period reaches the predetermined maximum secondary current on-period.

Moreover, the control circuit includes a timer circuit for prohibiting the operation of the output power limiting circuit for a certain period of time after oscillation is started to allow the switching element to perform the switching operation.

Further, the control circuit includes a maximum secondary current on-period control terminal for externally adjusting the maximum secondary current on-period.

Moreover, the output power limiting circuit determines which one of continuous mode and discontinuous mode is established for the switching operation of the switching element, based on the output signal from the secondary current on-period detection circuit and the driving signal of the switching element, and the output power limiting circuit sets the maximum secondary current on-period at different values according to the respective modes.

As has been discussed, according to the present invention, even when the first DC voltage fluctuates which is the primary-side input voltage of the switching power supply, an overload on the secondary side is detected according to the secondary current on-period not depending upon the input voltage, thereby achieving stable overload protection.

Furthermore, the secondary current on-period is detected according to the voltage of the auxiliary winding of the transformer, so that the circuit of the power supply can be configured without using expensive components such as a photocoupler for detecting an overload on the secondary side and an IC for detecting a secondary-side output current. Thus it is possible to further reduce the cost and size of the power supply.

### BRIEF DESCRIPTION OF THE DRAWINGS

FIG. 1 is a circuit block diagram showing the configuration of a switching power supply according to a first embodiment of the present invention;

FIG. 2 is a circuit block diagram showing another structural example of the switching power supply according to the first embodiment;

FIG. 3 is a circuit diagram showing a structural example of a secondary current on-period detection circuit in the switching power supply of the first embodiment;

FIG. 4 shows a waveform chart of respective parts to illustrate the operations of the switching power supply according to the first embodiment;

FIG. 5 shows a comparison between an output current-output voltage characteristic in the switching power supply of the first embodiment and the prior art;

FIG. 6 is a circuit block diagram showing the configuration of a switching power supply according to a second embodiment of the present invention;

FIG. 7 is a circuit block diagram showing the configuration of a switching power supply according to a third embodiment of the present invention;

FIG. 8 is a circuit diagram showing a structural example of a continuity/discontinuity determining circuit in the switching power supply of the third embodiment;

FIG. 9 shows a waveform chart of respective parts to illustrate the operations of the switching power supply according to the third embodiment;

FIG. 10 is a circuit block diagram showing the configuration of a switching power supply according to a fourth embodiment of the present invention; and

FIG. 11 is a circuit block diagram showing the configuration of a switching power supply according to the prior art.

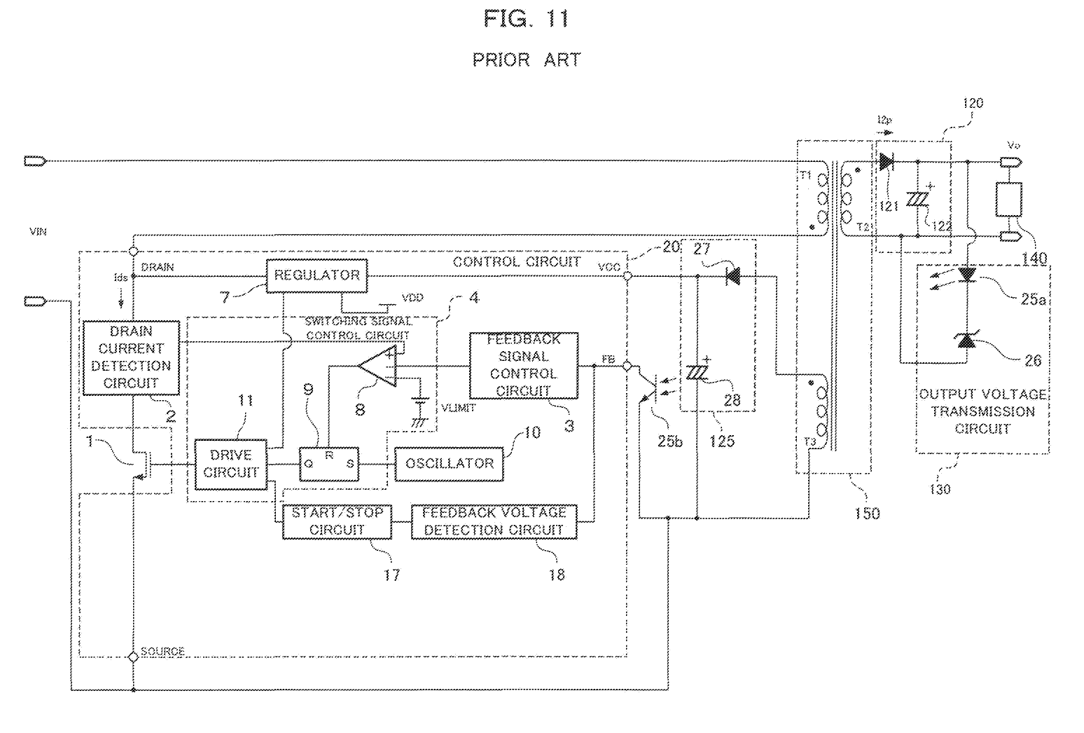

### DESCRIPTION OF THE EMBODIMENTS

A switching power supply according to embodiments of the present invention will be specifically described below with reference to the accompanying drawings.

### First Embodiment

The following will describe a switching power supply according to a first embodiment of the present invention.

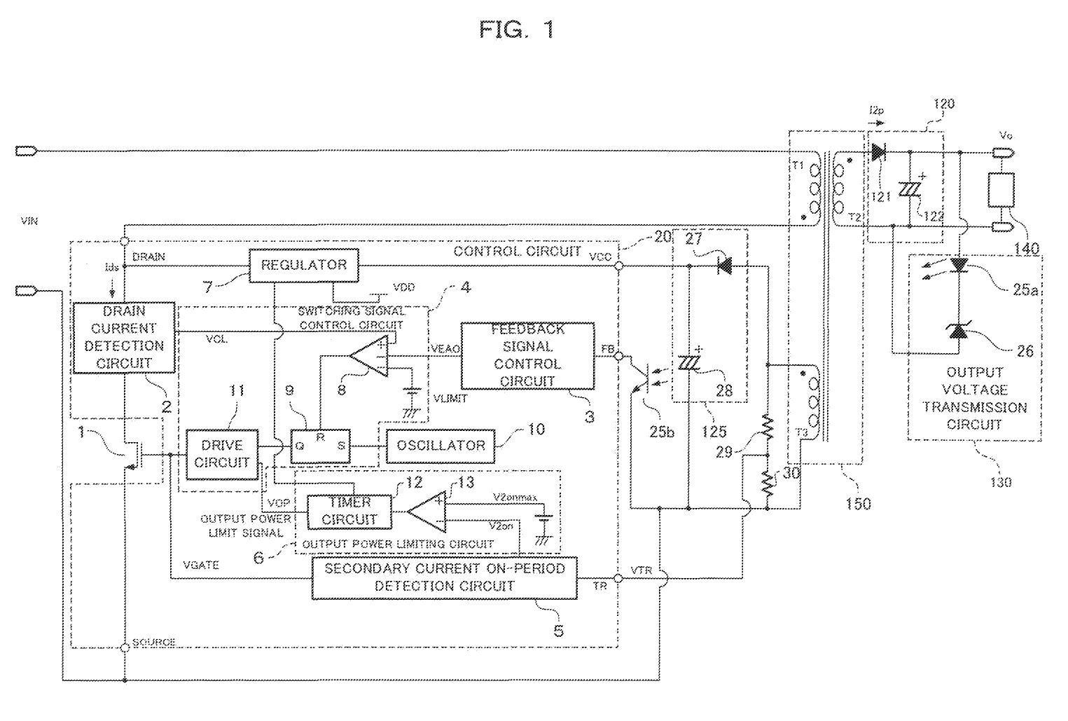

FIG. 1 is a circuit block diagram showing the configuration of the switching power supply according to the first embodiment. As shown in FIG. 1, a power converter transformer 150 has a primary winding T1, a secondary winding T2, and an auxiliary winding T3. The secondary winding T2 is opposite in polarity from the primary winding T1 and the switching power supply is a flyback power supply.

The primary winding T1 of the power converter transformer 150 has one terminal connected to the positive terminal of the input side (primary side) of the switching power supply, and the other terminal connected to the negative terminal of the input side (primary side) of the switching power supply via a switching element 1 which is a semiconductor element having a high withstand voltage.

The switching element 1 has an input terminal, an output terminal, and a control terminal. The input terminal is connected to the primary winding T1 and the output terminal is connected to the negative terminal of the input side of the switching power supply. The switching element 1 performs a switching operation (oscillation) so as to electrically couple or decouple the input terminal and the output terminal in response to a control signal applied to the control terminal. The switching element 1 is, for example, a power MOSFET.

By the switching operation (oscillating operation) of the switching element 1, a DC voltage (first DC voltage) VIN supplied from the terminal of the input side of the switching power supply to the primary winding T1 is converted to a pulse voltage (high frequency voltage), and the pulse voltage is transferred to the secondary winding T2 and the auxiliary winding T3. The auxiliary winding T3 has the same polarity as the secondary winding T2. A pulse voltage generated on the auxiliary winding T3 is proportionate to a pulse voltage generated on the secondary winding T2.

In this way, by the switching operation of the switching element 1 connected to the primary winding T1 fed with the DC voltage VIN, the voltages are generated on the secondary winding T2 and the auxiliary winding T3 of the power converter transformer 150 according to the turns ratio to the primary winding T1.

The secondary winding T2 of the power converter transformer 150 is connected to an output voltage generating circuit 120. The output voltage generating circuit 120 generates a secondary-side output voltage (second DC voltage) Vo from an AC voltage generated on the secondary winding T2. To be specific, the output voltage generating circuit 120 includes a rectifier diode 121 and a smoothing capacitor 122. The rectifier diode 121 and the smoothing capacitor 122 rectify and smooth the pulse voltage generated on the secondary winding T2 and generate the output voltage Vo. The output voltage Vo is supplied to a load 140 connected to the terminal of the output side (secondary side) of the switching power supply.

Further, to the output voltage generating circuit 120, an output voltage transmission circuit 130 is connected. To be specific, the output voltage transmission circuit 130 includes a photocoupler 25a and a voltage detection circuit 26. The photocoupler 25a and the voltage detection circuit 26 detect the level of the output voltage generated by the output voltage generating circuit 120, converts the level to an optical signal, and transmits the signal to a photocoupler 25b provided on the primary side.

The auxiliary winding T3 of the power converter transformer 150 is connected to an auxiliary power generating circuit 125. To be specific, the auxiliary power generating circuit 125 includes a rectifier diode 27 and a smoothing capacitor 28. The auxiliary power generating circuit 125 generates an auxiliary power supply voltage VCC from the generated voltage of the auxiliary winding T3 and supplies the circuit current of a control circuit 20 from a VCC terminal.

The switching operation of the switching element 1 is controlled by the control circuit 20. The control circuit 20 is made up of a semiconductor device (a semiconductor device for a switching power supply) formed on the same semiconductor substrate and has five terminals of a DRAIN terminal, the VCC terminal, an FB terminal, a TR terminal, and a SOURCE terminal as external connection terminals.

The DRAIN terminal is connected to the primary winding T1 of the power converter transformer 150, and the input terminal of the switching element 1 is connected to the primary winding T1 via the DRAIN terminal. The VCC terminal is connected to the auxiliary power generating circuit 125 and is fed with the auxiliary power supply voltage VCC. The SOURCE terminal is connected to the negative terminal of the input side of the switching power supply, and the output terminal of the switching element 1 is connected to the negative terminal of the input side of the switching power supply via the SOURCE terminal.

The control circuit 20 generates the control signal applied to the control terminal of the switching element 1 based on the voltage of the VCC terminal (auxiliary power supply voltage VCC) and controls the switching operation of the switching element 1.

The following will describe the internal configuration of the control circuit 20.

In the control circuit 20, a regulator 7 is connected to the VCC terminal and the DRAIN terminal. The regulator 7 supplies a current to an internal circuit power supply VDD of the control circuit 20 from one of the DRAIN terminal and the VCC terminal, and stabilizes the voltage of the internal circuit power supply VDD at a constant value.

In other words, before the switching operation of the switching element 1 is started, the regulator 7 supplies a current from the DRAIN terminal to the internal circuit power supply VDD and also supplies a current to the smoothing capacitor 28 via the VCC terminal to increase the auxiliary power supply voltage VCC and the voltage of the internal circuit power supply VDD.

After the switching operation of the switching element 1 is started, the regulator 7 stops the current supply from the DRAIN terminal to the VCC terminal. In other words, when the auxiliary power supply voltage VCC is not lower than a constant value, the regulator 7 supplies a current based on the auxiliary power supply voltage VCC to the internal circuit power supply VDD from the VCC terminal. By supplying the circuit current of the control circuit 20 thus from the auxiliary winding T3, power consumption can be effectively reduced.

To the FB terminal, the photocoupler 25b is connected. The FB terminal acts as a control terminal for feedback control.

A feedback signal control circuit 3 detects the value of current (signal level) flowing to the photocoupler 25b through the FB terminal, and generates a feedback control signal VEAO according to the detected value of current.

The feedback control signal VEAO which is the output signal of the feedback signal control circuit 3 configured thus is supplied to a drain current control circuit 8 of a switching signal control circuit 4.

An oscillator (oscillator circuit) 10 oscillates with a constant period a clock signal for turning on the switching element 1. The clock signal is inputted to the set terminal of an RS latch circuit 9 in the switching signal control circuit 4.

The switching signal control circuit 4 turns on the switching element 1 at a time corresponding to the signal oscillated by the oscillator 10, and turns off the switching element 1 at a time corresponding to the signal level of the feedback control signal VEAO from the feedback signal control circuit 3.

To be specific, the switching signal control circuit 4 is made up of the drain current control circuit 8, the RS latch circuit 9, and a drive circuit 11.

A drain current detection circuit (element current detection circuit) 2 is disposed between the DRAIN terminal and the input terminal of the switching element 1, detects the current value of a current (drain current) ID passing through the switching element 1, and generates a drain current detection signal (element current detection signal) VCL having a voltage value corresponding to the current value. The drain current detection signal VCL is supplied to the drain current control circuit 8 in the switching signal control circuit 4.

To the drain current control circuit 8, an overcurrent protection reference voltage VLIMIT and the feedback control signal VEAO from the feedback signal control circuit 3 are supplied as reference voltages. The drain current control circuit 8 generates a signal for turning off the switching element 1 when the drain current detection signal VCL reaches the lower one of the overcurrent protection reference voltage VLIMIT and the feedback control signal VEAO. The signal is inputted to the reset terminal R of the RS latch circuit 9.

The RS latch circuit 9 has the set terminal S fed with the clock signal from the oscillator 10 and the reset terminal R fed with the signal from the drain current control circuit 8. From a set state to a reset state, the RS latch circuit 9 generates a signal for turning on the switching element 1. In other words, the turn-on of the switching element 1 is controlled by the clock signal from the oscillator 10 and the turn-off of the switching element 1 is controlled by the signal from the drain current control circuit 8.

The drive circuit 11 generates a control signal for drive control on the switching operation of the switching element 1 based on a signal generated on the Q terminal of the RS latch circuit 9 and an output power limit signal VOP generated by an output power limiting circuit 6.

After that, the RS latch circuit 9 outputs the clock signal and a basic control signal from the drain current control circuit. Normally, the output signal of the output power limiting circuit 6 outputs Low level. When an overload is detected and then High level is outputted as the output power limit signal VOP after a lapse of a certain period of time, the drive circuit 11 outputs Low and oscillation is stopped. This configuration is represented by NAND symbols for the sake of simplification. The drive circuit 11 is actually made up of, for example, a latch circuit.

To the TR terminal, the auxiliary winding T3 is connected via series voltage dividing resistors 29 and 30. In the control circuit 20, a secondary current on-period detection circuit 5 is connected to the TR terminal.

The secondary current on-period detection circuit 5 is also connected to the drive circuit 11. The secondary current on-period detection circuit 5 detects a time period (secondary current on-period) during which a current passes through the secondary winding T2 of the transformer 150, from the pulse voltage generated on the auxiliary winding T3 and an output signal VGATE of the drive circuit 11. Further, the secondary current on-period detection circuit 5 converts the time period to a voltage level to generate a secondary current on-period signal V2on, and outputs the signal to the output power limiting circuit 6.

The output power limiting circuit 6 includes a timer circuit 12 and a secondary current on-period comparator 13. When the secondary current on-period signal V2on reaches a maximum secondary current on-period signal V2onmax, the output of the secondary current on-period comparator 13 is inverted and the timer circuit 12 starts operating. When the output of the secondary current on-period comparator 13 is kept for a certain period of time (timer time) after the output of the secondary current on-period comparator 13 is inverted, the timer circuit 12 outputs the output power limit signal VOP to the drive circuit 11.

In other words, in case of an overload on the secondary side, the overload is detected by the auxiliary winding T3 and the secondary current on-period detection circuit 5. After the overload is detected, when the overloaded state is kept for the certain period of time (timer time), the switching power supply is safely stopped by the output power limit signal VOP.

It is generally known that the timer circuit 12 operates with an overload protection function according to an intermittent control system and a timer latch system.

In the intermittent control system, the signal of the RS latch circuit 9 is invalidated and the switching operation of the switching element 1 is stopped for a certain period of time. After that, the signal of the RS latch circuit 9 is validated and the switching operation is permitted for a relatively short period of time. When an overloaded state is canceled in a time period during which the signal of the RS latch circuit 9 is validated, the switching element 1 returns to a normal operation. When the overloaded state is not canceled in the time period during which the signal of the RS latch circuit 9 is validated, the signal of the RS latch circuit 9 is invalidated again for the certain period of time to stop the switching operation. In other words, this cycle is kept until the overloaded state is canceled or an input is cut off.

In the case of the timer latch system, the invalidated state of the RS latch circuit 9 is not canceled without external operations for cutting off the input after the signal of the RS latch circuit 9 is invalidated by the output power limit signal VOP.

The regulator 7 controls the start/stop of the control circuit 20. The start/stop signal of the regulator 7 is connected to the timer circuit 12. The operation of the timer circuit 12 is disabled for a certain period of time after the control circuit 20 is started.

Thus at startup, it is possible to prevent erroneous detection of an overload before the output rises, thereby preventing faulty startup.

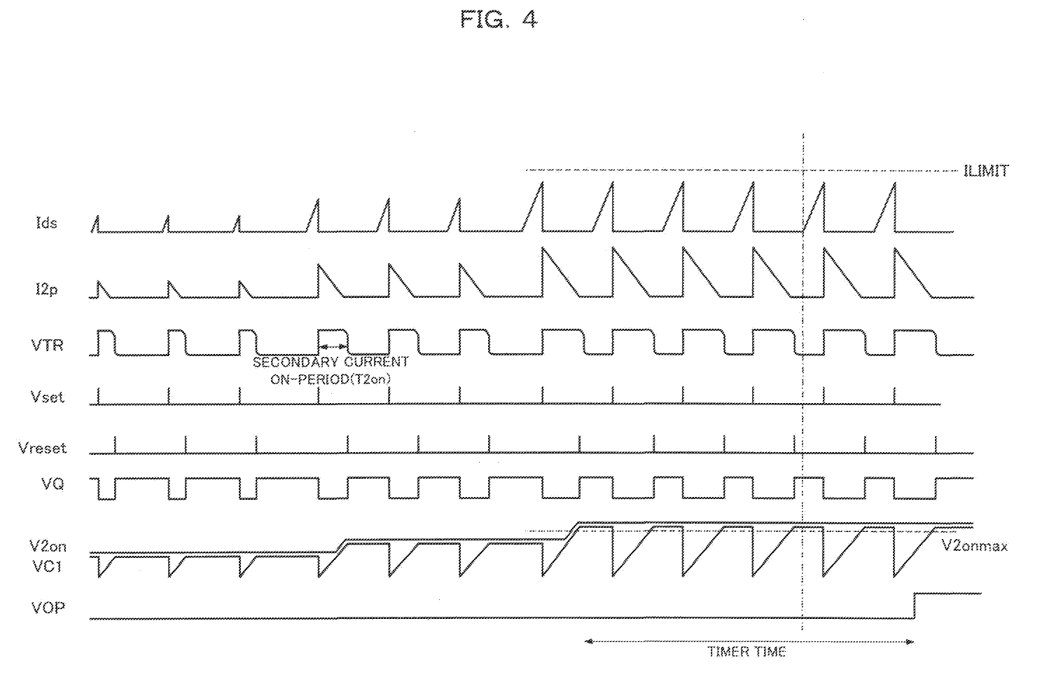

FIG. 4 is a time chart of an element current Ids of the switching element 1, a current I2p passing through the secondary winding T2, an input voltage VTR of the TR terminal, and the secondary current on-period signal V2on when a load is gradually increased in the switching power supply of the first embodiment. In FIG. 4, before the element current Ids reaches a maximum element current ILIMIT, the secondary current on-period signal V2on reaches the maximum secondary current on-period signal V2onmax.

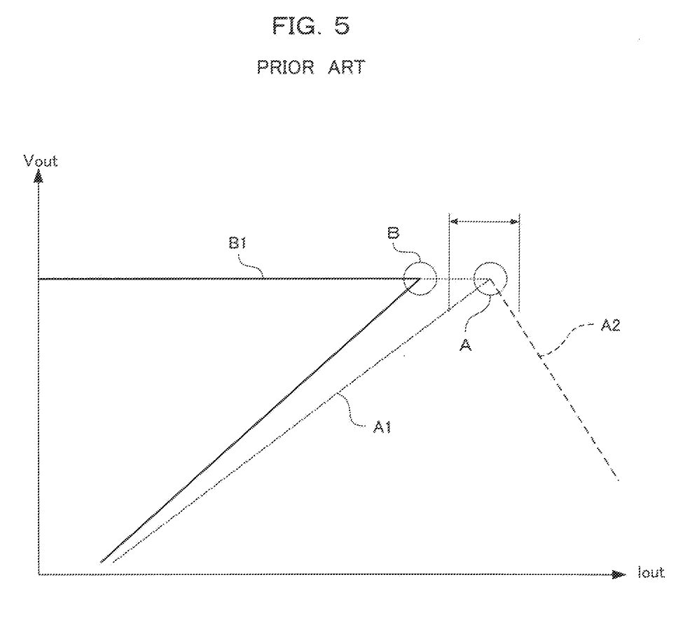

FIG. 5 shows output current-output voltage characteristics in the switching power supply of the first embodiment. In FIG. 5, characteristic B1 indicated by a solid line corresponds to the switching power supply of the first embodiment (the present invention) and is simultaneously compared with output characteristic A1 indicated by a dotted line according to the prior art.

As shown in FIG. 5, in the prior art represented by characteristic A1, the element current Ids reaches the maximum element current ILIMIT at an overload detection point (point A), whereas in the present invention, the secondary current on-period is set as shown in FIG. 4 at the maximum secondary current on-period at a small load corresponding to a point (point B) which is lower than the point where the element current Ids reaches the maximum element current ILIMIT.

According to this setting, in the case of an operation in discontinuous mode, an output current Io is equal to the mean value of the current of the secondary winding and is expressed as follows:

$$Io = \frac{I 2 p \times T 2 on}{2 \times T} \qquad ( 2 )$$

where T2on is a secondary current on-period and T is an oscillation period (the switching period of the switching element) controlled by the oscillator 10.

The current I2p passing through the secondary winding T2 is expressed as follows:

$$I 2 p = \frac{Vo \times T 2 on}{L 2} \qquad ( 3 )$$

where L2 is the inductance of the secondary winding T2 of the transformer. In this expression, a voltage drop caused by the rectifier diode of the secondary side, an output cable and the like is ignored for the sake of simplicity.

Based on expressions (2) and (3), the output current Io is expressed as follows:

$$Io = \frac{Vo \times T 2 {on}^{2}}{2 \times T \times L 2} = \frac{Vo \times T 2 {on}^{2} \times {n}^{2}}{2 \times T \times L} \qquad ( 4 )$$

Based on expression (4), an output current when an overload is detected according to the present invention is expressed as follows:

$$Io = \frac{Vo \times T 2 on {max}^{2} \times {n}^{2}}{2 \times T \times L} \qquad ( 5 )$$

where T2onmax is a secondary current on-period corresponding to the maximum secondary current on-period signal V2onmax.

When comparing expression (5) with expression (1) representing the maximum output current of the prior art, it is found that ILIMIT is not included in expression (5).

As has been discussed, it is understood that ILIMIT is not always kept constant because of a delay time and so on in the control circuit 20 and ILIMIT considerably depends upon the L value of the transformer and an input voltage.

Thus according to the present invention, as expressed in expression (5), the output current does not include ILIMIT when an overload is detected. Thus it is understood that the dependence on input voltage can be eliminated in theory.

In FIG. 1, the secondary current on-period is detected using the auxiliary winding T3 of the transformer 150. The secondary current on-period may be detected by monitoring the voltage of the DRAIN terminal of the switching element 1.

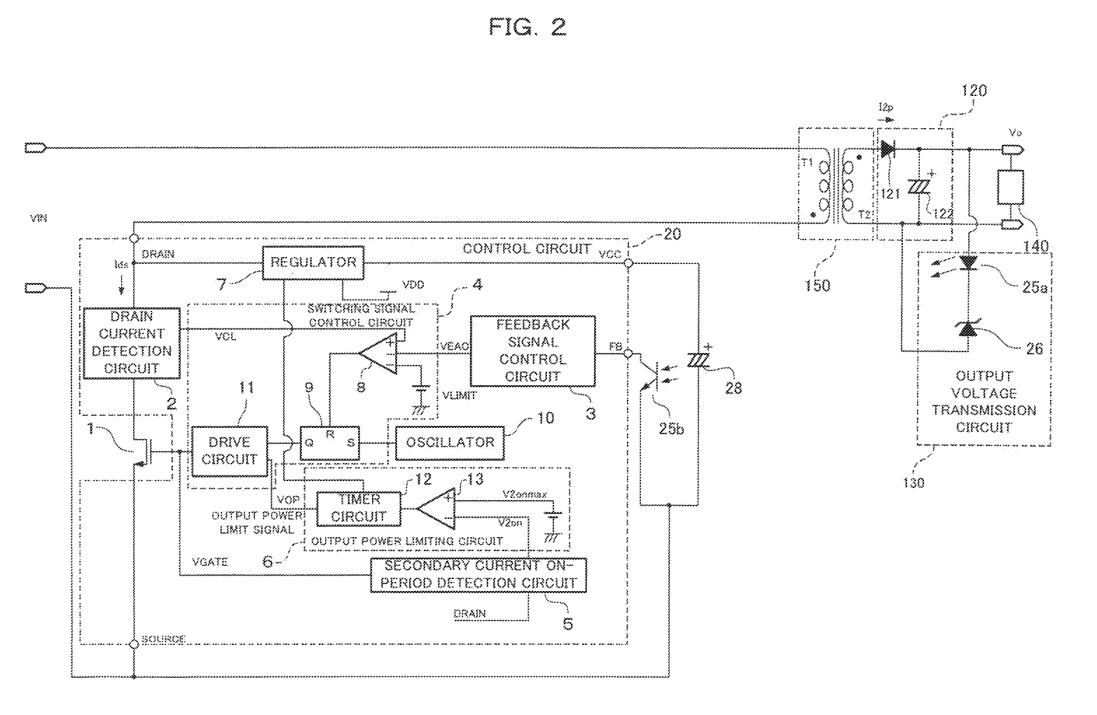

FIG. 2 shows a switching power supply for detecting the signal of a secondary current on-period from the DRAIN terminal without using the auxiliary winding T3, as another structural example of the first embodiment shown in FIG. 1.

As shown in FIG. 2, when the signal is directly detected from the DRAIN terminal, it is necessary to increase the withstand voltage of the input terminal of the secondary current on-period detection circuit. By supplying power from the DRAIN terminal having a high voltage instead of VCC having a relatively low voltage, power consumption on the primary side is disadvantageously increased. However, power supply from the DRAIN terminal can reduce the number of external circuit components, thereby reducing the total cost of the power supply.

In this case, although the secondary current on-period detection circuit 5 requires a high-withstand voltage element, it is possible to omit the auxiliary winding T3 of the transformer, so that the transformer is expected to be reduced in size.

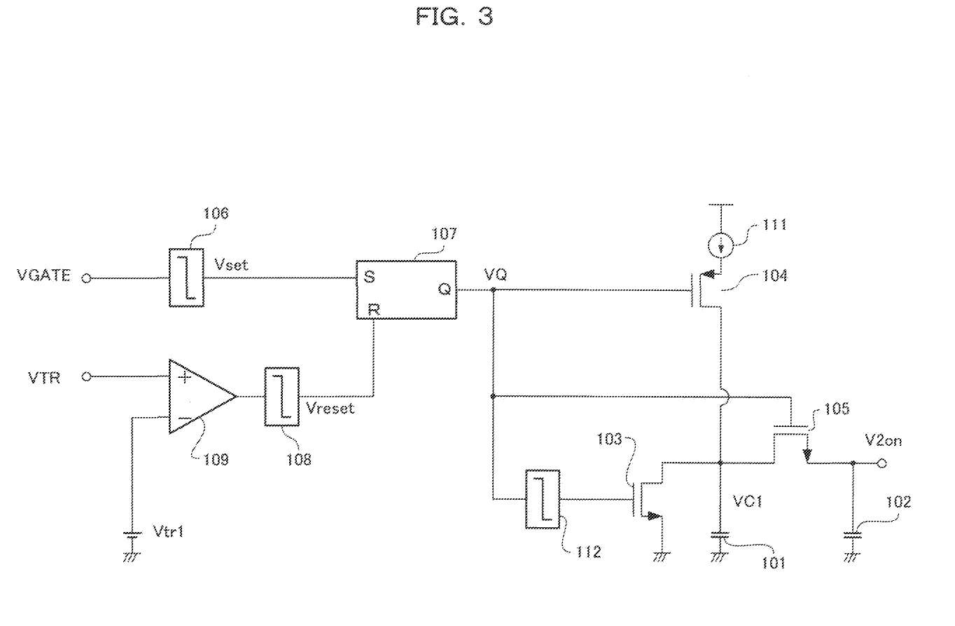

FIG. 3 shows a structural example of the secondary current on-period detection circuit 5 in the switching power supply of the first embodiment.

The secondary current on-period detection circuit 5 is made up of pulse generators 106, 108, and 112, an RS latch circuit 107, a comparator 109, NchMOSFETs 103 and 105, a PchMOSFET 104, capacitors 101 and 102, and a constant current source 111.

The negative input of the comparator 109 is fed with a reference voltage Vtr1 and the positive input of the comparator 109 is fed with VTR from the TR terminal. The output of the comparator 109 is inputted to the R (reset) terminal of the RS latch circuit 107 through the pulse generator 108. When the flyback voltage waveform VTR inputted from the auxiliary winding T3 to the TR terminal is reduced below Vtr1 by the comparator 109 and the pulse generator 108, a pulse signal Vreset is generated.

VGATE denotes an input signal to the switching element 1. VGATE is inputted to the S (set) terminal of the RS latch circuit 107 through the pulse generator 106, and the pulse generator 106 generates a pulse signal Vset when the switching element 1 is turned off.

In other words, in response to the Vset signal and the Vreset signal, the RS latch circuit 107 outputs a High signal VQ from the time the switching element 1 is turned off until the time the TR terminal detects the completion of the passage of a secondary current.

The output VQ of the RS latch circuit 107 is connected to the gate of the NchMOSFET 105 and the gate of the PchMOSFET 104 and is also connected to the gate of the NchMOSFET 103 via the pulse generator 112.

The pulse generator 112 generates a one-shot pulse signal when the input signal VQ changes from High to Low. In other words, the NchMOSFET 103 is turned on every time the switching element 1 is turned off.

The drain terminals of the NchMOSFETs 103 and 105 are connected to the capacitor 101 and the source terminal of the NchMOSFET 105 is connected to the capacitor 102. Further, the capacitor 101 is connected to the constant current source 111 via the PchMOSFET 104.

FIG. 4 shows the operation waveforms of respective parts in the secondary current on-period detection circuit 5 configured thus.

As shown in FIG. 4, the NchMOSFET 103 is turned on only for a moment every time the switching element 1 is turned off, and the NchMOSFET 103 discharges, for each pulse, charge accumulated in the capacitor 101.

The PchMOSFET 104 is turned on in the secondary current on-period during which the capacitor 101 is charged by the constant current source 111.

Contrary to the PchMOSFET 104, the NchMOSFET 105 is turned on only in a period during which a current does not pass through a secondary-side transformer, and the NchMOSFET 105 transfers the voltage signal of the charged capacitor 101 to the capacitor 102.

In other words, the potential level of the capacitor 101 fluctuates for each pulse in proportion to the secondary current on-period. At the completion of the passage of the secondary current, the potential level is transferred to the capacitor 102 and the potential (V2on) of the capacitor 102 is kept until the end of the subsequent secondary current on-period.

In this way, the secondary current on-period detection circuit 5 in the switching power supply of the first embodiment converts the secondary current on-period T2on, which changes for each pulse, to a voltage signal on pulse-by-pulse basis.

### Second Embodiment

The following will describe a switching power supply according to a second embodiment of the present invention.

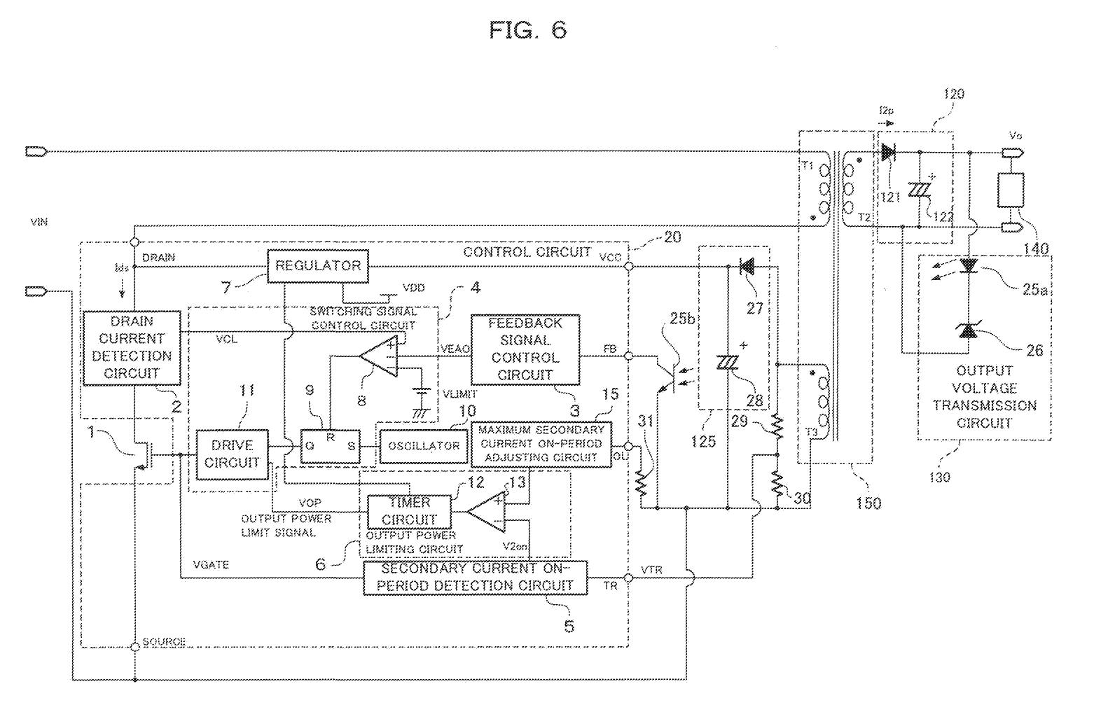

FIG. 6 is a block diagram showing a structural example of the switching power supply according to the second embodiment. Members corresponding to the members of the first embodiment are indicated by the same reference numerals and the explanation thereof is omitted.

A control circuit 20 of the switching power supply includes an external terminal OL and a maximum secondary current on-period adjusting circuit 15. The maximum secondary current on-period adjusting circuit 15 has the external terminal OL as an input and supplies a maximum secondary current on-period signal V2onmax to a secondary current on-period comparator 13.

The maximum secondary current on-period adjusting circuit 15 controls the maximum secondary current on-period signal V2onmax according to the current or voltage of the OL terminal.

In this configuration, for example, a resistor 31 is connected as an external element to the OL terminal, so that the maximum secondary current on-period signal V2onmax can be externally adjusted.

By providing a device for externally adjusting the maximum secondary current on-period signal V2onmax, the control circuit 20 configured in the same semiconductor chip can improve the design freedom of the switching power supply as compared with the first embodiment.

### Third Embodiment

The following will describe a switching power supply according to a third embodiment of the present invention.

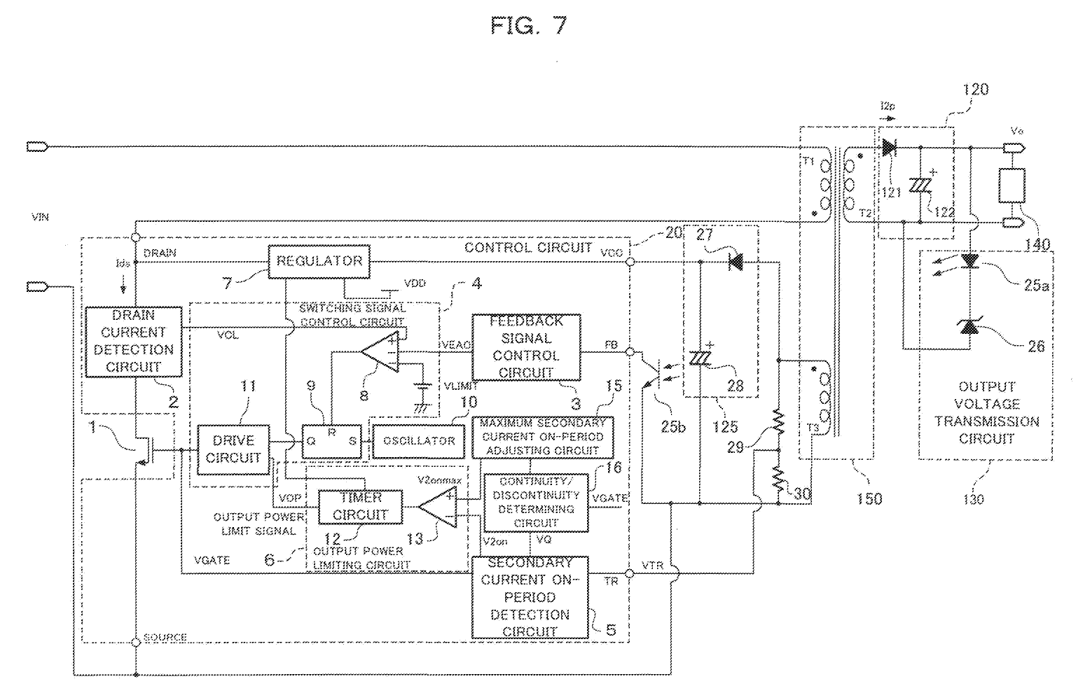

FIG. 7 is a block diagram showing a structural example of the switching power supply according to the third embodiment. Members corresponding to the members of the first embodiment are indicated by the same reference numerals and the explanation thereof is omitted.

In the switching power supply, a control circuit 20 includes a maximum secondary current on-period adjusting circuit 15 and a continuity/discontinuity determining circuit 16. The maximum secondary current on-period adjusting circuit 15 is connected to the continuity/discontinuity determining circuit 16, and the continuity/discontinuity determining circuit 16 is connected to a secondary current on-period detection circuit 5.

The continuity/discontinuity determining circuit 16 determines whether the switching power supply is in continuous mode or discontinuous mode based on an output signal VGATE of a drive circuit 11 and a signal VQ which is one of the output signals of the secondary current on-period detection circuit 5. When the continuity/discontinuity determining circuit 16 determines that the switching power supply is in continuous mode, a control signal Vq1 reducing a maximum secondary current on-period signal V2onmax is outputted to the maximum secondary current on-period adjusting circuit 15.

To be specific, VGATE and an inverted signal VQB of VQ are compared with each other and the continuity/discontinuity determining circuit 16 determines that the switching power supply is in continuous mode when VGATE and VQB are simultaneously turned on for at least a certain period of time.

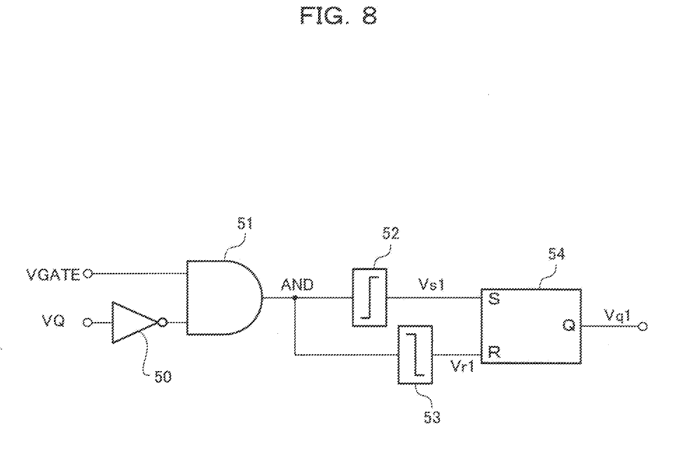

FIG. 8 shows a structural example of the continuity/discontinuity determining circuit 16 in the switching power supply of the third embodiment.

As shown in FIG. 8, the continuity/discontinuity determining circuit 16 is made up of an inverter 50, an AND circuit 51, pulse generators 52 and 53, and an RS latch circuit 54. The pulse generator 52 generates a one-shot pulse as a signal Vs1 when the input signal changes from Low to High. The pulse generator 53 generates a one-shot pulse as a signal Vr1 when the input signal changes from High to Low.

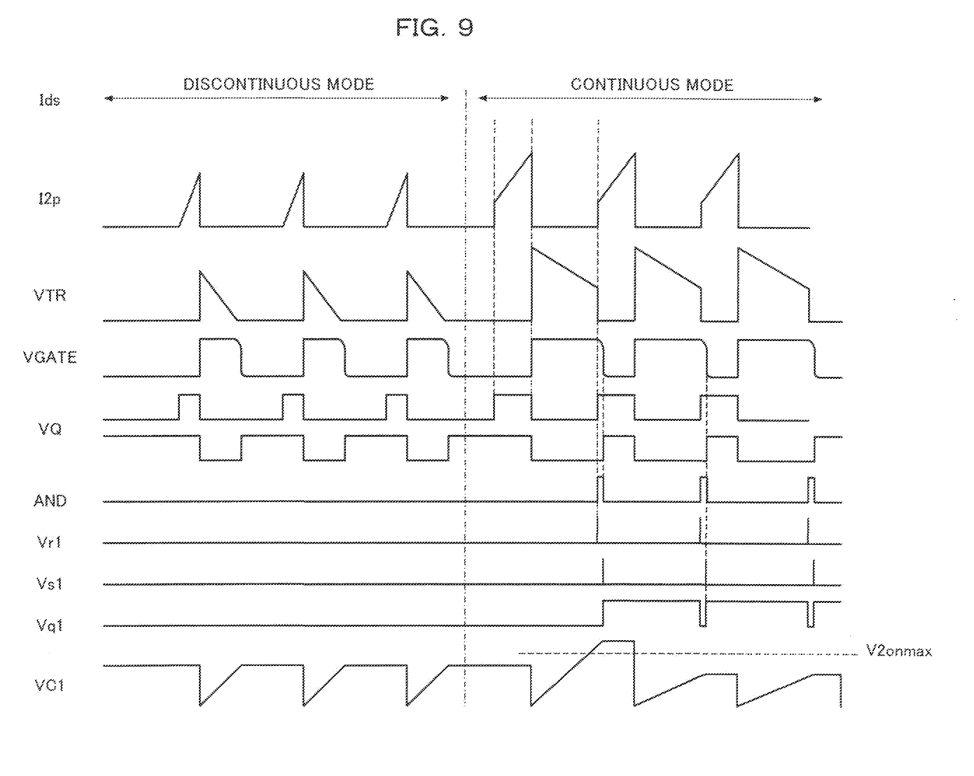

FIG. 9 is a timing chart showing the waveforms of respective parts to illustrate the operations of the continuity/discontinuity determining circuit 16 of FIG. 8. FIG. 9 is also a time chart showing the gate voltage VGATE of a switching element 1, an element current Ids, a current I2p passing through a secondary winding T2, an input voltage VTR of a TR terminal, an output AND of the AND circuit 51 of the continuity/discontinuity determining circuit 16, the input signals Vr1 and Vs1 and the output signal Vq1 of the RS latch circuit 54, a voltage signal VC1 of a capacitor 101 of the secondary current on-period detection circuit 5, and the output VQ of a RS latch circuit 107 in continuous mode and discontinuous mode.

From the driving signal VGATE of the switching element 1 and the signal VQ indicating a secondary current on-period detected by the secondary current on-period detection circuit 5, the signal Vq1 for determining continuous mode and discontinuous mode is obtained thus. The signal Vq1 is reset for each pulse, that is, every time the switching element 1 is turned on. The signal Vq1 decreases to Low for a moment but quickly returns to High while continuous mode is detected.

While Vq1 is High, the current of a constant current source 111 is reduced in the secondary current on-period detection circuit 5, so that the conversion rate of the secondary current on-period to a voltage in the secondary current on-period detection circuit 5 decreases and the maximum secondary current on-period serving as a reference value for detecting an overload increases.

In the first embodiment, an output current can be accurately controlled in discontinuous mode when an overload is detected. When continuous mode and discontinuous mode are established according to an input voltage, an overload is detected with a larger output current in continuous mode than in discontinuous mode.

In the third embodiment, even when the switching power supply is placed in continuous mode or discontinuous mode depending on the input voltage, the control circuit 20 determines whether the switching power supply is in continuous mode or discontinuous mode, and a proper overload detection level is set for each mode. Thus it is possible to reduce a difference in output current when an overload is detected.

### Fourth Embodiment

The following will describe a switching power supply according to a fourth embodiment of the present invention.

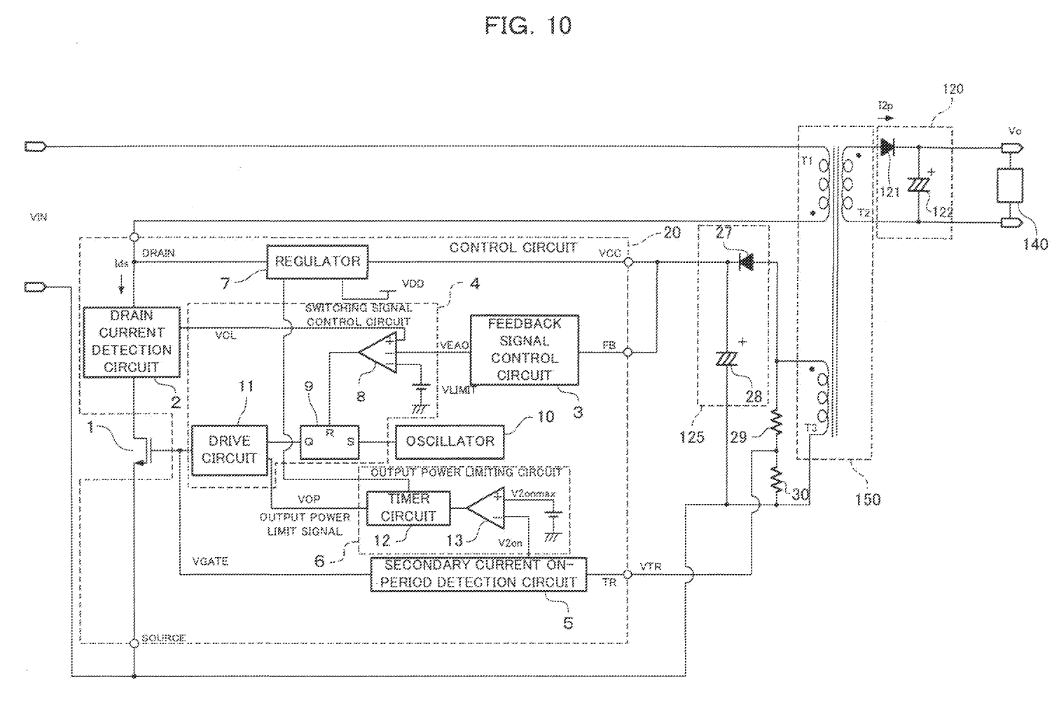

FIG. 10 is a block diagram showing a structural example of the switching power supply according to the fourth embodiment. Members corresponding to the members of the first embodiment are indicated by the same reference numerals and the explanation thereof is omitted.

In the switching power supply, a photocoupler and a control IC are not provided on the secondary side and an FB terminal is connected to a VCC terminal. In other words, In the first to third embodiments, the feedback signal control circuit 3 of the switching power supply performs feedback control using the current signal flowing to the photocoupler 25b through the FB terminal, whereas in the fourth embodiment, a feedback signal control circuit 3 of the switching power supply performs feedback control using a voltage signal applied from an auxiliary winding T3 of a transformer 150 through the FB terminal.

According to the configuration of FIG. 10, an output voltage is controlled with lower accuracy during constant voltage control. However, it is possible to eliminate the need for a photocoupler and a control IC on the secondary side, thereby achieving a switching power supply at low cost with a small space.

What is claimed is:

1. A switching power supply comprising:
a transformer having a primary winding, a secondary winding, and an auxiliary winding;
a switching element connected to the primary winding to switch a first DC voltage supplied to the primary winding;
a control circuit for controlling a switching operation of the switching element;
an output voltage generating circuit which converts, to a second DC voltage, an AC voltage generated on the secondary winding by the switching operation of the switching element and supplies the second DC voltage to a load; and
an output voltage transmission circuit which detects the second DC voltage from the output voltage generating circuit, generates a transmission signal changing with the second DC voltage, and transmits the signal to the control circuit,
the control circuit controlling the switching operation of the switching element to perform constant voltage control on the second DC voltage from the output voltage generating circuit,
the control circuit comprising:
an element current detection circuit which detects a current passing through the switching element and outputs the current as an element current detection signal;
a feedback signal control circuit which compares the transmission signal from the output voltage transmission circuit with a reference level and outputs an error as a feedback signal;
a switching signal control circuit which controls the second DC voltage from the output voltage generating circuit by controlling a switching signal for turning on/off the switching operation of the switching element based on the element current detection signal from the element current detection circuit and the feedback signal from the feedback signal control circuit;
a secondary current on-period detection circuit which detects, from a voltage generated on the auxiliary winding by the switching operation of the switching element, a time when passage of a secondary current through the secondary winding is completed after the switching element is turned off, generates a signal indicating a time when the secondary current is cut off, detects as a secondary current on-period a time period from a time the switching element is turned off until the time the secondary current is cut off, converts the time period to one of a voltage signal and a current signal, and outputs the signal; and
an output power limiting circuit which compares the output signal of the secondary current on-period detection circuit and a signal indicating a predetermined maximum secondary current on-period, and outputs an output power limit signal to the switching signal control circuit when the output signal of the secondary current on-period detection circuit is larger than the maximum secondary current on-period signal, the output power limit signal reducing or stopping power supply to the load,
the maximum secondary current on-period signal being set so as to correspond to the secondary current on-period when the constant voltage control is performed on the second DC voltage from the output voltage generating circuit by the switching operation of the switching element.

2. The switching power supply according to claim 1, wherein the output power limiting circuit outputs the output power limit signal to the switching signal control circuit when the secondary current on-period is kept larger than the maximum secondary current on-period for a certain period of time after the secondary current on-period reaches the predetermined maximum secondary current on-period.

3. The switching power supply according to claim 1, wherein the control circuit comprises a timer circuit for prohibiting an operation of the output power limiting circuit for a certain period of time after oscillation is started to allow the switching element to perform the switching operation.

4. The switching power supply according to claim 1, wherein the control circuit comprises a maximum secondary current on-period control terminal for externally adjusting the maximum secondary current on-period.

5. The switching power supply according to claim 1, wherein the output power limiting circuit determines which one of continuous mode and discontinuous mode is established for the switching operation of the switching element, based on the output signal from the secondary current on-period detection circuit and a driving signal of the switching element, and the output power limiting circuit sets the maximum secondary current on-period at different values according to the respective modes.
